(19) United States
(12) Patent Application Publication
(10) Pub. No.: US 2026/0202624 A1
(43) Pub. Date: Jul. 16, 2026

(54) SEMICONDUCTOR MODULE AND METHOD FOR MANUFACTURING SEMICONDUCTOR MODULE

(71) Applicant: KYOCERA CORPORATION, Kyoto-shi, Kyoto (JP)

(72) Inventors: Misa TAKAHASHI, Kyotanabe-shi, Kyoto (JP); Takashi YAMAMOTO, Kyoto-shi, Kyoto (JP); Tomoyuki AKAHOSHI, Nara-shi, Nara (JP)

(73) Assignee: KYOCERA CORPORATION, Kyoto-shi, Kyoto (JP)

(21) Appl. No.: 19/135,643

(22) PCT Filed: Dec. 5, 2023
(86) PCT No.: PCT/JP2023/043521

§ 371 Date: Jun. 4, 2025

(30) Foreign Application Priority Data
Dec. 12, 2022 (JP) 2022-198195

(51) Int. Cl. G02B 6/42

(52) U.S. Cl. CPC G02B 6/4202; G02B 6/4227

(57) ABSTRACT

A semiconductor module includes a substrate, a first connector, and a second connector. The first connector is provided on the substrate. The second connector is located on one end side of an optical fiber cable, and is optically connected to the first connector. The second connector includes a body portion and a protruding portion. The body portion accommodates the optical fiber cable therein. The protruding portion protrudes from the body portion, and has a second surface from which a distal end portion of the optical fiber cable is exposed.

### CROSS-REFERENCE TO RELATED APPLICATIONS

This application is national stage application of International Application No. PCT/JP2023/043512, filed on Dec. 5, 2023, which designates the United States, incorporated herein by reference, and which claims the benefit of priority from Japanese Patent Application No. 2022-198195, filed on Dec. 12, 2022, the entire contents of which are incorporated herein by reference.

### TECHNICAL FIELD

An embodiment of the disclosure relates to a semiconductor module and a method for manufacturing the semiconductor module.

### BACKGROUND OF INVENTION

Known semiconductor modules include a semiconductor module in which a semiconductor device (hereinafter, also referred to as an optical device) for converting an electrical signal into an optical signal is mounted on a substrate. An optical fiber cable for transmitting the converted optical signal from the optical device to the outside may be connected to the semiconductor module (see Patent Document 1).

### CITATION LIST

### Patent Literature

Patent Document 1: JP 6311558 B

### SUMMARY

A semiconductor module of the present disclosure includes a substrate, a first connector, and a second connector. The first connector is provided on the substrate. The second connector is located on one end side of an optical fiber cable, and is optically connected to the first connector. The second connector includes a body portion and a protruding portion. The body portion accommodates the optical fiber cable therein. The protruding portion protrudes from the body portion, and has a second surface from which a distal end portion of the optical fiber cable is exposed.

### BRIEF DESCRIPTION OF THE DRAWINGS

FIG. 1 is a perspective view of a semiconductor module according to an embodiment, as viewed from diagonally above.

FIG. 2 is a perspective view of the semiconductor module according to the embodiment, as viewed from diagonally below.

FIG. 3 is a cross-sectional view of the semiconductor module according to the embodiment.

FIG. 4 is a top view of a first connector and a second connector according to the embodiment.

FIG. 5 is a view for explaining a step of aligning the second connector according to the embodiment.

FIG. 6 is a view for explaining the step of aligning the second connector according to the embodiment.

FIG. 7 is a view for explaining the step of aligning the second connector according to the embodiment.

FIG. 8 is a view for explaining the step of aligning the second connector according to the embodiment.

FIG. 9 is a top view of a second connector according to another embodiment 1.

FIG. 10 is a top view of a second connector according to another embodiment 2.

FIG. 11 is a cross-sectional view of a first connector and a second connector according to another embodiment 3.

FIG. 12 is a view for explaining the step of aligning the second connector according to another embodiment 3.

FIG. 13 is a view for explaining the step of aligning the second connector according to another embodiment 3.

### DESCRIPTION OF EMBODIMENTS

Embodiments of a semiconductor module and a method for manufacturing the semiconductor module disclosed in the present application are described below with reference to the accompanying drawings. Note that the present disclosure is not limited by the following embodiments. The embodiments can be appropriately combined within a range so as not to contradict each other in terms of processing content. In the following embodiments, the same portions are denoted by the same reference signs, and redundant descriptions are omitted.

In the following embodiments, expressions such as “certain”, “orthogonal”, “perpendicular”, and “parallel” may be used, but these expressions need not mean exactly “certain”, “orthogonal”, “perpendicular”, and “parallel”. That is, each of the expressions described above allows for deviations in, for example, manufacturing accuracy or installation accuracy.

In the drawings referenced below, in order to facilitate understanding, an orthogonal coordinate system may be illustrated, in which an X-axis direction, a Y-axis direction, and a Z-axis direction orthogonal to each other are defined and a positive Z-axis direction is a vertically upward direction.

Known semiconductor modules include a semiconductor module in which a semiconductor device (hereinafter, also referred to as an optical device) for converting an electrical signal into an optical signal is mounted on a substrate. An optical fiber cable for transmitting the converted optical signal from the optical device to the outside may be connected to the semiconductor module.

However, in the above-described related art, a joining strength between a connector on the semiconductor device side and a connector on the optical fiber cable side may not be sufficient. Thus, the optical fiber cable may possibly be detached from the semiconductor module.

In this regard, a technology that can overcome the above-described problems and improve the joining strength of the optical fiber cable is expected to be implemented.

### Overall Configuration of Semiconductor Module

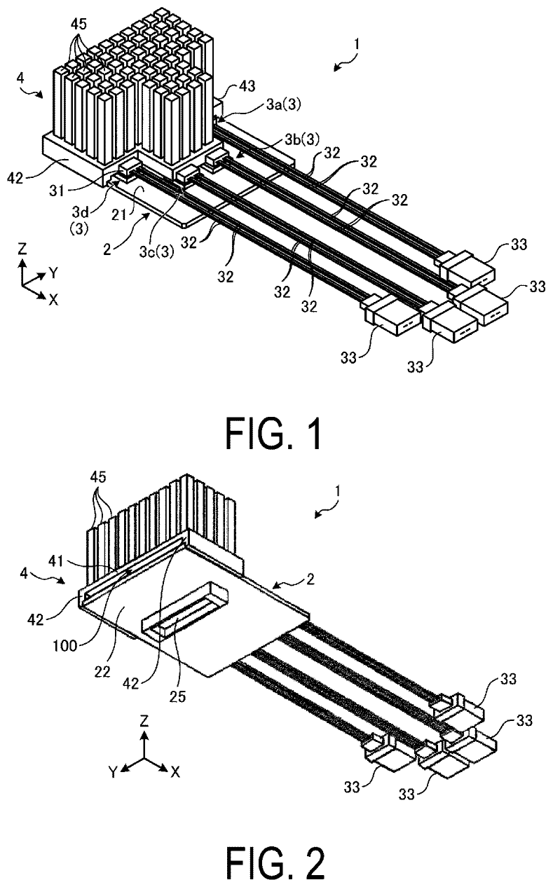

First, the overall configuration of a semiconductor module 1 according to an embodiment is described with reference to FIGS. 1 and 2. FIG. 1 is a perspective view of the semiconductor module 1 according to the embodiment, as viewed from diagonally above. FIG. 2 is a perspective view of the semiconductor module 1 according to the embodiment, as viewed from diagonally below.

Note that each of the following embodiments describes an example in which the semiconductor module 1 is an optical module in which optical devices 3 are mounted on a substrate; however, the semiconductor module according to the present disclosure is not necessarily an optical module.

As illustrated in FIGS. 1 and 2, the semiconductor module 1 according to the embodiment includes a substrate 2, a plurality of optical devices 3 (optical devices 3a to 3d), and a heat dissipation member 4.

The substrate 2 has a quadrilateral plate shape in plan view, for example. On a first surface 21 (here, an upper surface) of the substrate 2, in addition to the plurality of optical devices 3a to 3d and the heat dissipation member 4, a power source IC, a control IC, a chip resistor, and the like (not illustrated) are located. A capacitor, a coil, and the like (not illustrated) may be located on the first surface 21 of the substrate 2.

A connector 25 is located on a second surface 22 (here, a lower surface) of the substrate 2. The substrate 2 is electrically connected to a motherboard via the connector 25.

The optical device 3 is a semiconductor device that converts an electrical signal into an optical signal. The optical device 3 may also convert an optical signal into an electrical signal. A second connector 31 is located on an upper surface of each optical device 3. The second connector 31 is connected to an optical connector 33 via a cable group including a plurality of optical fiber cables 32.

The heat dissipation member 4 is a so-called heat sink, and is located above the plurality of optical devices 3. Note that the heat dissipation member 4 may not necessarily cover the entirety of the plurality of optical devices 3 from above. That is, as illustrated in FIG. 1, the upper surfaces of the plurality of optical devices 3 may be partially exposed from the heat dissipation member 4.

The heat dissipation member 4 is close to the plurality of optical devices 3, and dissipates heat generated from the optical devices 3 to the outside of the semiconductor module 1. Note that the heat dissipation member 4 may be in direct contact with the optical devices 3. Alternatively, the heat dissipation member 4 may be in contact with the optical devices 3 via a thermal interface material (TIM). That is, the heat dissipation member 4 may be thermally connected to the plurality of optical devices 3.

The heat dissipation member 4 may be made from a metal having relatively high thermal conductivity, such as aluminum, copper, or iron. TIM is a composite material containing a thermally-conductive filler in a resin.

The heat dissipation member 4 includes a plate-shaped portion 41, a plurality of leg portions 42, and a plurality of heat dissipation bodies 45. The plate-shaped portion 41 is a plate-shaped portion spaced apart from and facing the first surface 21 of the substrate 2. The plurality of leg portions 42 are provided on the plate-shaped portion 41. Specifically, the plurality of leg portions 42 extend from the plate-shaped portion 41 toward the substrate 2 and come into contact with the substrate 2 (are installed on the substrate 2).

Each of the leg portions 42 has a shape in which the thickness thereof partially increases from the plate-shaped portion 41. The leg portions 42 may be integrated with the plate-shaped portion 41. The plurality of leg portions 42 may be connected to the plate-shaped portion 41 and the substrate 2. The plurality of leg portions 42 extend in a certain direction (here, in the X axis direction).

The plurality of heat dissipation bodies 45 are located on a surface of the plate-shaped portion 41, on an opposite side to a surface of the plate-shaped portion 41, facing the substrate 2. FIGS. 1 and 2 illustrate an example in which each of the heat dissipation bodies 45 is pin-shaped (that is, a heat dissipation pin); however, each of the heat dissipation bodies 45 may be plate-shaped (that is, a heat dissipation fin), for example.

A blower (not illustrated), such as a cooling fan, for sending air to the semiconductor module 1 may be located on a negative side in the X axis direction relative to the semiconductor module 1. Such a blower generates air flowing toward the X-axis positive direction.

The air sent from the blower hits the plurality of heat dissipation bodies 45, and flows along the first surface 21 of the substrate 2 to pass through a ventilation path 100 formed between the substrate 2 and the plate-shaped portion 41 of the heat dissipation member 4.

In the embodiment, since the air hits the plurality of optical devices 3 located on an outlet side of the ventilation path 100, the heat dissipation efficiency of the plurality of optical devices 3 can be further improved.

### Connection Configuration of Optical Fiber Cable

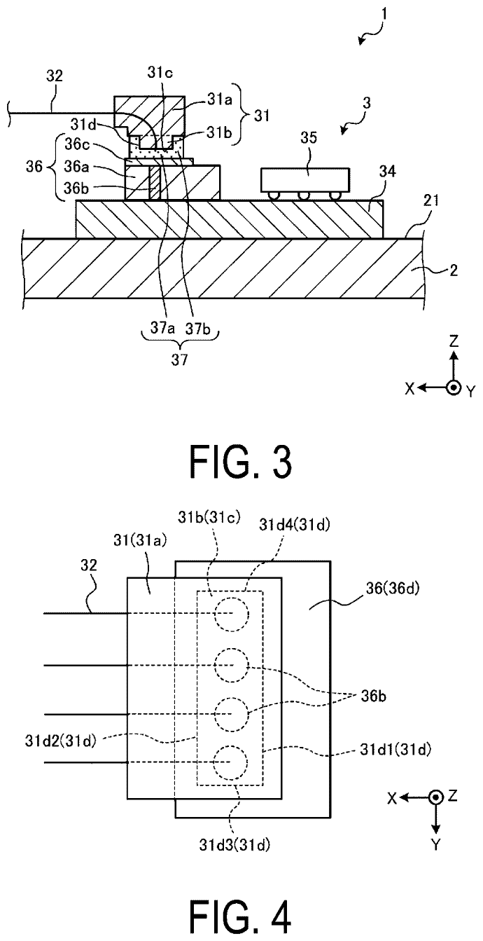

Subsequently, a connection configuration of the optical fiber cables 32 in the semiconductor module 1 according to the embodiment is described with reference to FIGS. 3 and 4. FIG. 3 is a cross-sectional view of the semiconductor module 1 according to the embodiment. FIG. 4 is a top view of the first connector 36 and the second connector 31 according to the embodiment.

As illustrated in FIG. 3, the optical device 3 according to the embodiment includes a substrate 34, an optical element 35, and the first connector 36. The optical element 35 is an example of a semiconductor element.

The substrate 34 supports various components (for example, the optical element 35 and the first connector 36) constituting the optical device 3. The substrate 34 is, for example, a silicon substrate.

The optical element 35 is located on a main surface of the substrate 34, for example. The optical element 35 includes a laser diode (LD), a driver, and a receiver, and converts an electric signal into an optical signal. The optical element 35 may also convert an optical signal into an electrical signal. Note that in the optical element 35 according to the embodiment, the LD may be formed separately from the driver and the receiver.

The first connector 36 is located, for example, on the main surface of the substrate 34. The first connector 36 is optically connected to the optical element 35 via an optical transmission path (not illustrated) located on the substrate 34 or the like.

The first connector 36 includes a body portion 36a, a plurality of optical pins 36b, and a cover member 36c. The body portion 36a accommodates the plurality of optical pins 36b therein, and supports the plurality of optical pins 36b so that the optical pins 36b do not come into contact with each other.

Each of the optical pins 36b is optically connected to an optical transmission path extending from the optical element 35, and transmits an optical signal. The plurality of optical pins 36b are optically connected to the plurality of optical fiber cables 32 accommodated in the second connector 31, respectively.

As illustrated in FIG. 3, the optical pin 36b is located to extend toward the second connector 31 (for example, along the Z-axis direction). Note that the optical pin 36b according to the embodiment may be located to be inclined with respect to the Z-axis direction.

In addition, as illustrated in FIG. 4, the plurality of optical pins 36b are located side by side along, for example, a predetermined first direction (Y-axis direction in the drawing).

The cover member 36c is located to cover the distal end portions of the plurality of optical pins 36b located side by side, and protects the distal end portions of the plurality of optical pins 36b. The cover member 36c is made of a member that can transmit an optical signal (for example, optical glass). The second connector 31 is located to face the cover member 36c (that is, the plurality of optical pins 36b).

The cover member 36c and the second connector 31 are fixed by a fixing member 37. The fixing member 37 is made of, for example, an adhesive that can transmit an optical signal (for example, a UV curable resin).

The second connector 31 is located on one end side of the plurality of optical fiber cables 32, and is optically connected to the first connector 36. The second connector 31 includes a body portion 31a and a protruding portion 31b. The body portion 31a accommodates the plurality of optical fiber cables 32 therein.

The protruding portion 31b is a portion protruding from the body portion 31a. The protruding portion 31b protrudes, for example, toward a side of the body portion 31a facing the first connector 36 (negative side in the Z-axis direction in the drawing). The protruding portion 31b may be formed integrally with the body portion 31a, or may be formed separately from the body portion 31a, and may be joined to the body portion 31a by a joining member or the like.

The protruding portion 31b has a bottom surface 31c and a plurality of lateral surfaces 31d. The bottom surface 31c is an example of a second surface, and is a flat surface facing the first connector 36. The distal end portions of the plurality of optical fiber cables 32 are exposed from the bottom surface 31c.

Note that the distal end portions of the plurality of optical fiber cables 32 may not necessarily be exposed from the bottom surface 31c, and may be located inside the protruding portion 31b in the vicinity of the bottom surface 31c, for example.

As illustrated in FIG. 4, the bottom surface 31c according to the embodiment has a rectangular shape in plan view. The plurality of lateral surfaces 31d are surfaces that are in contact with the sides of the bottom surface 31c having a rectangular shape and intersect the bottom surface 31c.

In the embodiment, since the second connector 31 has the protruding portion 31b, as illustrated in FIG. 3, not only the bottom surface 31c, but also the plurality of lateral surfaces 31d contribute to the joining with the first connector 36. That is, in the embodiment, since the second connector 31 has the protruding portion 31b, the joining area of the second connector 31 can be increased.

Thus, the joining strength between the first connector 36 and the second connector 31 can be improved. Consequently, according to the embodiment, the joining strength of the optical fiber cables 32 can be improved.

In the embodiment, the protruding portion 31b may protrude toward a side facing the first connector 36. Thus, the fixing member 37 smoothly wraps around the plurality of lateral surfaces 31d of the protruding portion 31b, so that the joining strength between the first connector 36 and the second connector 31 can be further improved.

Consequently, according to the embodiment, the joining strength of the optical fiber cables 32 can be further improved.

In the embodiment, the surface roughness of at least one lateral surface 31d of the protruding portion 31b may be larger than the surface roughness of the bottom surface 31c. Thus, a so-called anchor effect occurs between the lateral surface 31d having a larger surface roughness and the fixing member 37, so that the joining strength between the first connector 36 and the second connector 31 can be further improved.

Consequently, according to the embodiment, the joining strength of the optical fiber cables 32 can be further improved. In the embodiment, the optical transmission efficiency between the first connector 36 and the second connector 31 can be improved by reducing the surface roughness of the bottom surface 31c.

In addition, in the embodiment, the surface roughness of all the lateral surfaces 31d of the protruding portion 31b may be larger than the surface roughness of the bottom surface 31c. Thus, an anchor effect occurs between all the lateral surfaces 31d and the fixing member 37, so that the joining strength between the first connector 36 and the second connector 31 can be further improved.

Consequently, according to the embodiment, the joining strength of the optical fiber cables 32 can be further improved. In this case, preferably, a surface roughness Ra of the bottom surface 31c is 0.01 μm or less, and a surface roughness Ra of the lateral surface 31d is from 100 times to 500 times larger than the surface roughness Ra of the bottom surface 31c. Specifically, the surface roughness Ra of the lateral surface 31d may be equal to or larger than 1 μm and equal to or smaller than 5 μm.

In the embodiment, the first connector 36 and the second connector 31 may be fixed by the fixing member 37 such as an adhesive. Thus, since the first connector 36 and the second connector 31 can be easily fixed to each other, the manufacturing cost of the semiconductor module 1 can be reduced.

In addition, in the embodiment, as illustrated in FIG. 3, the fixing member 37 may have a thin portion 37a and a thick portion 37b. The thin portion 37a is a portion of the fixing member 37 facing the bottom surface 31c. The thick portion 37b is located around the thin portion 37a and is thicker than the thin portion 37a.

In this way, since the fixing member 37 has the thin portion 37a, the distance between the optical pin 36b and the optical fiber cable 32 can be shortened, so that the optical transmission efficiency between the first connector 36 and the second connector 31 can be improved.

Since the fixing member 37 has the thick portion 37b, the joining strength between the first connector 36 and the second connector 31 can be further improved.

### Step of Aligning Second Connector

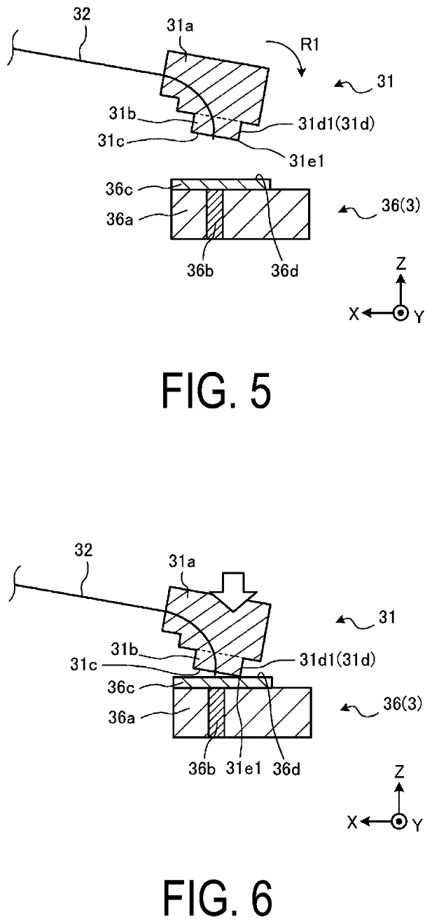

Subsequently, details of a step of aligning the second connector 31 in the manufacturing process of the semiconductor module 1 according to the embodiment are described with reference to FIGS. 5 to 8. FIGS. 5 to 8 are views for explaining the step of aligning the second connector 31 according to the embodiment.

In the embodiment, first, as illustrated in FIG. 5, a controller of a manufacturing apparatus (not illustrated) inclines the second connector 31 in a predetermined rotation direction R1 with respect to a second direction (the X-axis direction in the drawing) in which the optical fiber cable 32 extends in the semiconductor module 1 (see FIG. 3).

A first side 31e1 formed by the bottom surface 31c and a lateral surface 31d1 on the negative side in the X-axis direction relative to the bottom surface 31c is closer to the first connector 36 than the other sides. The lateral surface 31d1 is an example of a first lateral surface.

Subsequently, as illustrated in FIG. 6, the controller of the manufacturing apparatus (not illustrated) moves the second connector 31 in the inclined state toward the first connector 36, and brings the first side 31e1 into contact with a main surface 36d of the cover member 36c in the first connector 36.

Subsequently, the controller of the manufacturing apparatus measures a height position of the first side 31e1 when the first side 31e1 is in contact with the first connector 36.

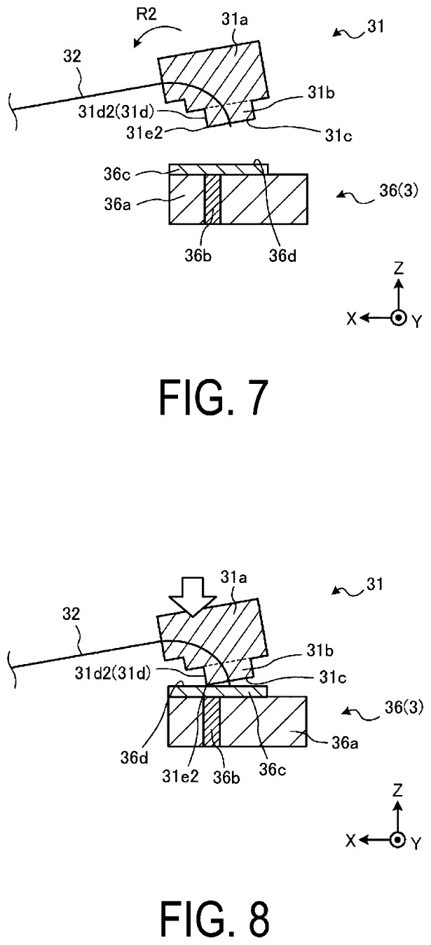

Subsequently, as illustrated in FIG. 7, the controller of the manufacturing apparatus (not illustrated) inclines the second connector 31 in a rotation direction R2 opposite to the predetermined rotation direction R1 with respect to the second direction (the X-axis direction in the drawing) in which the optical fiber cable 32 extends in the semiconductor module 1 (see FIG. 3).

A second side 31e2 formed by the bottom surface 31c and a lateral surface 31d2 on the positive side in the X-axis direction relative to the bottom surface 31c is closer to the first connector 36 than the other sides. The lateral surface 31d2 is an example of a second lateral surface.

Subsequently, as illustrated in FIG. 8, the controller of the manufacturing apparatus (not illustrated) moves the second connector 31 in the inclined state toward the first connector 36, and brings the second side 31e2 into contact with the main surface 36d of the cover member 36c in the first connector 36.

Subsequently, the controller of the manufacturing apparatus measures a height position of the second side 31e2 when the second side 31e2 is in contact with the first connector 36.

Subsequently, the controller of the manufacturing apparatus adjusts the inclination of the bottom surface 31c on the basis of the height position of the first side 31e1 measured in the state illustrated in FIG. 6, and the height position of the second side 31e2 measured in the state illustrated in FIG. 8.

Specifically, the controller of the manufacturing apparatus adjusts the inclination of the bottom surface 31c on the basis of the height position of the first side 31e1 and the height position of the second side 31e2 so that the bottom surface 31c and the main surface 36d of the cover member 36c are parallel to each other in the cross-sectional view of the XZ plane.

This can reduce the occurrence of inclination between the first connector 36 and the second connector 31 in the cross-sectional view of the XZ plane. Consequently, according to the embodiment, the optical fiber cable 32 and the optical pin 36b can be accurately aligned with each other.

### Other Embodiments

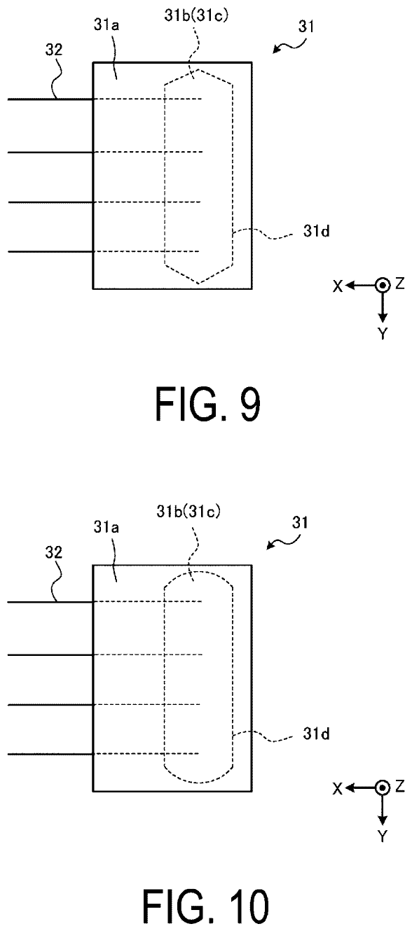

Subsequently, the semiconductor module 1 according to various other embodiments is described with reference to FIGS. 9 to 13. FIG. 9 is a top view of the second connector 31 according to another embodiment 1.

As illustrated in FIG. 9, another embodiment 1 is different from the above-described embodiment in terms of the planar shape of the protruding portion 31b. Specifically, in another embodiment 1, the bottom surface 31c of the protruding portion 31b may have a hexagonal shape instead of a rectangular shape.

Thus, the area of the lateral surface 31d can be increased, so that the joining area of the second connector 31 can be further increased.

Consequently, according to another embodiment 1, the joining strength between the first connector 36 and the second connector 31 can be further improved, so that the joining strength of the optical fiber cables 32 can be further improved. The bottom surface 31c of the protruding portion 31b may have a polygonal shape such as an octagonal shape.

FIG. 10 is a top view of the second connector 31 according to another embodiment 2. As illustrated in FIG. 10, in another embodiment 2, the bottom surface 31c of the protruding portion 31b may have a rounded rectangular shape.

Thus, the area of the lateral surface 31d can be increased, so that the joining area of the second connector 31 can be further increased.

Consequently, according to another embodiment 2, the joining strength between the first connector 36 and the second connector 31 can be further improved, so that the joining strength of the optical fiber cables 32 can be further improved. The bottom surface 31c of the protruding portion 31b may have an oval shape.

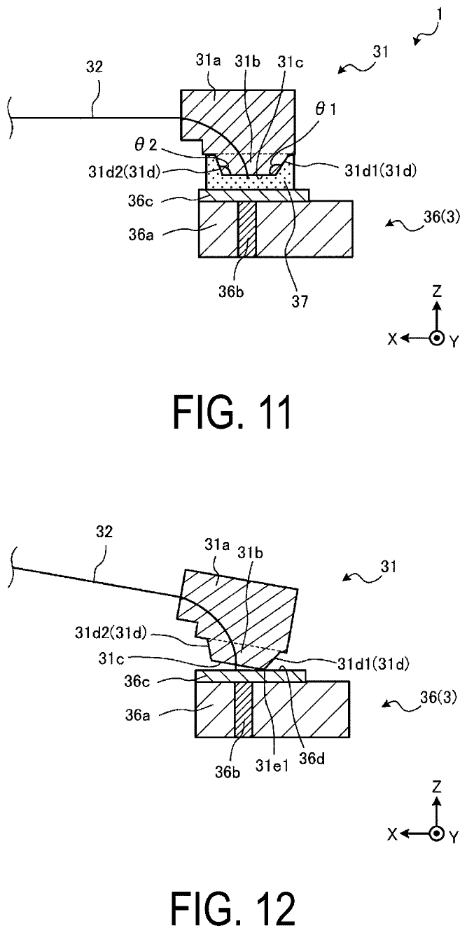

FIG. 11 is a cross-sectional view of the first connector 36 and the second connector 31 according to another embodiment 3. As illustrated in FIG. 11, another embodiment 3 is different from the above-described embodiment in terms of the cross-sectional shape of the protruding portion 31b.

Specifically, in another embodiment 3, when viewed in cross-section taken along the XZ plane, the protruding portion 31b may have a tapered shape tapered toward the bottom surface 31c.

Thus, since the second connector 31 has the protruding portion 31b having a tapered shape, not only the bottom surface 31c but also the plurality of lateral surfaces 31d contribute to the joining with the first connector 36. That is, in another embodiment 3, since the second connector 31 has the protruding portion 31b having a tapered shape, the joining area of the second connector 31 can be increased.

Thus, the joining strength between the first connector 36 and the second connector 31 can be improved. Consequently, according to another embodiment 3, the joining strength of the optical fiber cables 32 can be improved.

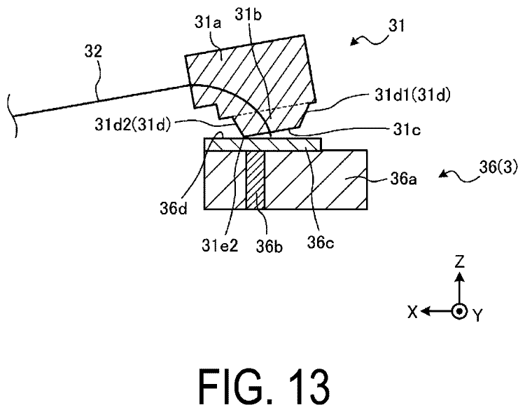

In another embodiment 3, by forming the protruding portion 31b into a tapered shape tapered toward the bottom surface 31c, the step of aligning the second connector 31 can be performed more accurately. The reason for this is described with reference to FIGS. 12 and 13.

FIGS. 12 and 13 are views for explaining the step of aligning the second connector 31 according to another embodiment 3.

Similarly to the above-described embodiments, in another embodiment 3, first, as illustrated in FIG. 12, the controller of the manufacturing apparatus (not illustrated) inclines the second connector 31 in the predetermined rotation direction R1 (see FIG. 5) with respect to the second direction (the X-axis direction in the drawing).

The first side 31e1 formed by the bottom surface 31c and the lateral surface 31d1 on the negative side in the X-axis direction relative to the bottom surface 31c is closer to the first connector 36 than the other sides.

Subsequently, the controller of the manufacturing apparatus moves the second connector 31 in the inclined state toward the first connector 36, and brings the first side 31e1 into contact with the main surface 36d of the cover member 36c in the first connector 36.

Subsequently, the controller of the manufacturing apparatus measures a height position of the first side 31e1 when the first side 31e1 is in contact with the first connector 36.

Subsequently, in another embodiment 3, since the protruding portion 31b has a tapered shape in the cross-sectional view of the XZ plane, a first angle θ1 (see FIG. 11) formed by the bottom surface 31c and the lateral surface 31d1 in contact with the first side 31e1 is larger than 90°.

Thus, since the contact area of the first side 31e1 to the main surface 36d of the cover member 36c can be increased, the controller of the manufacturing apparatus can detect contact of the first side 31e1 with the first connector 36 with high sensitivity.

That is, in another embodiment 3, by setting the first angle θ1 formed by the bottom surface 31c and the lateral surface 31d1 to be larger than 90°, the controller of the manufacturing apparatus can accurately measure the height position of the first side 31e1.

Subsequently, as illustrated in FIG. 13, the controller of the manufacturing apparatus (not illustrated) inclines the second connector 31 in the rotation direction R2 (see FIG. 7) opposite to the predetermined rotation direction R1 (see FIG. 5) with respect to the second direction (the X-axis direction in the drawing).

The second side 31e2 formed by the bottom surface 31c and the lateral surface 31d2 on the positive side in the X-axis direction relative to the bottom surface 31c is closer to the first connector 36 than the other sides.

Subsequently, the controller of the manufacturing apparatus moves the second connector 31 in the inclined state toward the first connector 36, and brings the second side 31e2 into contact with the main surface 36d of the cover member 36c in the first connector 36.

Subsequently, the controller of the manufacturing apparatus measures a height position of the second side 31e2 when the second side 31e2 is in contact with the first connector 36.

In another embodiment 3, since the protruding portion 31b has a tapered shape in a cross-sectional view of the XZ plane, a second angle θ2 (see FIG. 11) formed by the bottom surface 31c and the lateral surface 31d2 in contact with the second side 31e2 is larger than 90°.

Thus, since the contact area of the second side 31e2 to the main surface 36d of the cover member 36c can be increased, the controller of the manufacturing apparatus can detect contact of the second side 31e2 with the first connector 36 with high sensitivity.

That is, in another embodiment 3, by setting the second angle θ2 formed by the bottom surface 31c and the lateral surface 31d2 to be larger than 90°, the controller of the manufacturing apparatus can accurately measure the height position of the second side 31e2.

As described above, in another embodiment 3, by forming the protruding portion 31b in the tapered shape in the cross-sectional view of the XZ plane, the occurrence of inclination between the first connector 36 and the second connector 31 can be further reduced in the cross-sectional view of the XZ plane.

Consequently, according to another embodiment 3, the optical fiber cable 32 and the optical pin 36b can be aligned with each other more accurately.

In another embodiment 3, the first angle θ1 formed by the bottom surface 31c and the lateral surface 31d1, and the second angle θ2 formed by the bottom surface 31c and the lateral surface 31d2 may be different from each other.

For example, in the aligning step, the first angle θ1 corresponding to the first side 31e1 that first comes into contact with the main surface 36d may be set larger than the second angle θ2 corresponding to the second side 31e2 that subsequently comes into contact with the main surface 36d.

In this way, the first angle θ1 is set larger, thereby detecting contact of the first side 31e1 with the first connector 36 with even higher sensitivity, where the first side 31e1 first comes into contact with the main surface 36d.

By setting the second angle θ2 to be smaller than the first angle θ1, the dimension of the protruding portion 31b in the X-axis direction can be reduced, so that the size of the second connector 31 can be reduced.

Note that FIG. 11 illustrates an example in which both the first angle θ1 and the second angle θ2 are larger than 90°; however, the present disclosure is not limited to this example, and the first angle θ1 may be, for example, larger than 90° and the second angle θ2 may be, for example, 90°.

Although not illustrated, in another embodiment 3, the protruding portion 31b may have a tapered shape tapered toward the bottom surface 31c when viewed in cross-section taken along the YZ plane.

In other words, in another embodiment 3, both an angle formed by the bottom surface 31c and a lateral surface 31d3 (see FIG. 4) on the positive side in the Y-axis direction, and an angle formed by the bottom surface 31c and a lateral surface 31d4 (see FIG. 4) on the negative side in the Y-axis direction may be larger than 90°.

Thus, in the step of aligning the second connector 31, the height position of a side located between the bottom surface 31c and the lateral surface 31d3 can be accurately measured, and the height position of a side located between the bottom surface 31c and the lateral surface 31d4 can be accurately measured.

Consequently, according to another embodiment 3, the occurrence of inclination between the first connector 36 and the second connector 31 can be reduced in the cross-sectional view of the YZ plane.

Although the embodiments of the present disclosure have been described above, the present disclosure is not limited to the above embodiments, and various changes can be made without departing from the spirit of the present disclosure.

Additional effects and other aspects can be easily derived by a person skilled in the art. Therefore, a wide variety of aspects of the present disclosure are not limited to the specific details and representative embodiments represented and described above. Consequently, various changes can be made without departing from the spirit or scope of the general inventive concepts defined by the appended claims and their equivalents.

Note that the present technique can also have the following configurations.
(1)
A semiconductor module including:
a substrate;
a first connector provided on the substrate; and
a second connector located on one end side of an optical fiber cable and optically connected to the first connector, in which
the second connector includes:
a body portion accommodating the optical fiber cable therein; and
a protruding portion protruding from the body portion and having a second surface from which a distal end portion of the optical fiber cable is exposed.
(2)
The semiconductor module according to (1) above, in which the protruding portion protrudes toward a side facing the first connector.
(3)
The semiconductor module according to (1) or (2) above, in which
the first connector includes a plurality of optical pins located side by side along a predetermined first direction, and
the protruding portion has a tapered shape tapered toward the second surface in a cross-sectional view taken along a plane perpendicular to the predetermined first direction.
(4)
The semiconductor module according to (3) above, in which
the protruding portion has a first lateral surface and a second lateral surface intersecting a second direction in which the optical fiber cable extends from the body portion, and
a first angle formed by the second surface and the first lateral surface, and a second angle formed by the second surface and the second lateral surface are different from each other.
(5)
The semiconductor module according to any one of (1) to (4) above, in which, in a cross-sectional view taken along a plane perpendicular to the second direction in which the optical fiber cable extends from the body portion, the protruding portion has a tapered shape tapered toward the second surface.
(6)
The semiconductor module according to any one of (1) to (5) above, in which
the protruding portion has a plurality of lateral surfaces intersecting the second surface, and a surface roughness of at least one lateral surface is larger than a surface roughness of the second surface.
(7)
The semiconductor module according to any one of (1) to (6) above, further including:
a fixing member located between the first connector and the second connector, and fixing the first connector and the second connector.
(8)
The semiconductor module according to (7) above, in which the fixing member includes:
a thin portion facing the second surface; and
a thick portion located around the thin portion and thicker than the thin portion.
(9)
A method for manufacturing a semiconductor module, the method including:
aligning a first connector and a second connector with each other, the first connector being provided on a first surface of a substrate, the second connector including a protruding portion protruding from a body portion accommodating an optical fiber cable therein, the protruding portion having a second surface from which a distal end portion of the optical fiber cable is exposed, in which
the aligning includes:
bringing a first side formed by the second surface and a first lateral surface intersecting the second surface into contact with the first connector, while inclining the second connector in a predetermined rotation direction with respect to a second direction in which the optical fiber cable extends from the body portion, and measuring a height position of the first side;
bringing a second side formed by the second surface and a second lateral surface located on an opposite side to the first lateral surface into contact with the first connector, while inclining the second connector in a rotation direction opposite to the predetermined rotation direction with respect to the second direction, and measuring a height position of the second side; and
adjusting an inclination of the second surface on a basis of the height position of the first side and the height position of the second side.

1. A semiconductor module comprising: a substrate;
a first connector provided on a first surface of the substrate; and
a second connector located on one end side of an optical fiber cable and optically connected to the first connector,
wherein the second connector comprises:
a body portion accommodating the optical fiber cable therein; and
a protruding portion protruding from the body portion, and including a second surface from which a distal end portion of the optical fiber cable is exposed.

2. The semiconductor module according to claim 1, wherein the protruding portion protrudes toward a side facing the first connector.

3. The semiconductor module according to claim 1, wherein
the first connector comprises a plurality of optical pins located side by side along first direction, and
the protruding portion includes a tapered shape tapered toward the second surface in a cross-sectional view taken along a plane perpendicular to the first direction.

4. The semiconductor module according to claim 3, wherein
the protruding portion includes a first lateral surface and a second lateral surface intersecting a second direction in which the optical fiber cable extends from the body portion, and
a first angle formed by the second surface and the first lateral surface, and a second angle formed by the second surface and the second lateral surface are different from each other.

5. The semiconductor module according to claim 1, wherein, in a cross-sectional view taken along a plane perpendicular to the second direction, the protruding portion includes a tapered shape tapered toward the second surface.

6. The semiconductor module according to claim 1, wherein
the protruding portion has a plurality of lateral surfaces intersecting the second surface, and
a surface roughness of at least one lateral surface is larger than a surface roughness of the second surface.

7. The semiconductor module according to claim 1, further comprising:
a fixing member located between the first connector and the second connector, and fixing the first connector and the second connector.

8. The semiconductor module according to claim 7, wherein the fixing member comprises:
a thin portion facing the second surface; and
a thick portion located around the thin portion and thicker than the thin portion.

9. A method for manufacturing a semiconductor module, the method comprising:
aligning a first connector and a second connector with each other, the first connector being provided on a first surface of a substrate, the second connector comprising a protruding portion protruding from a body portion accommodating an optical fiber cable therein, the protruding portion including a second surface from which a distal end portion of the optical fiber cable is exposed, wherein
the aligning comprises:
bringing a first side formed by the second surface and a first lateral surface intersecting the second surface into contact with the first connector, while inclining the second connector in a rotation direction with respect to a second direction in which the optical fiber cable extends from the body portion, and measuring a height position of the first side;
bringing a second side formed by the second surface and a second lateral surface located on an opposite side to the first lateral surface into contact with the first connector, while inclining the second connector in a rotation direction opposite to the rotation direction with respect to the second direction, and measuring a height position of the second side; and
adjusting an inclination of the second surface on a basis of the height position of the first side and the height position of the second side.
